(19) United States
(12) Patent Application Publication
(10) Pub. No.: US 2016/0076447 A1
(43) Pub. Date: Mar. 17, 2016

(54) COMPOSITE MATERIAL INLET PLENUM AND GAS TURBINE ENGINE SYSTEM COMPRISING SAID PLENUM

(71) Applicant: NUOVO PIGNONE SRL, Florence (IT)

(72) Inventors: Roberto MERLO, Florence (IT); Mario PECCHIOLI, Florence (IT); Pierenzo MORRIELLO, Florence (IT)

(21) Appl. No.: 14/888,722

(22) PCT Filed: Apr. 30, 2014
(86) PCT No.: PCT/EP2014/058916

§ 371 Date: Nov. 3, 2015

(30) Foreign Application Priority Data
May 3, 2013 (IT) FI 2013 A 000100

(51) Int. Cl. F02C 7/04; F02C 5/00; F02C 3/04

(52) U.S. Cl. CPC F02C 7/04; F02C 3/04; F02C 5/00; F05D 2220/32; F05D 2300/603; F05D 2300/43

(57) ABSTRACT

An air inlet plenum for a gas turbine engine is described. The air inlet plenum comprises a hollow body having an air inlet aperture and an air outlet aperture arranged and configured for connection to the gas turbine engine. The air inlet plenum comprises at least one removable portion, which is removable from the hollow body when the air inlet plenum is connected to a gas turbine engine. The air inlet plenum is at least partly made of fiber-reinforced plastic.

### CROSS-REFERENCE TO RELATED APPLICATIONS

This is a national stage application under 35 U.S.C. §371(c) of prior filed, co-pending PCT application Ser. No. PCT/EP2014/058916, filed on Apr. 30, 2014, which claims priority to Italian Patent Application Serial No. FI2013A000100 filed May 3, 2013 and titled COMPOSITE MATERIAL INLET PLENUM AND GAS TURBINE ENGINE SYSTEM COMPRISING SAID PLENUM. The above-listed applications are herein incorporated by reference.

### DESCRIPTION

1. Technical Field

Embodiments of the invention relate to gas turbine engines. More specifically, the disclosure relates to improvements concerning the manufacturing of the inlet plenum for gas turbine systems.

2. Background of the Invention

Gas turbine engines are used as a power source within a variety of applications. Gas turbine engines are used, for example, as prime movers in compression stations, for driving large turbo-compressors for pipeline applications, for processing refrigerating fluids in LNG systems and the like. Gas turbine engines are also used as prime movers for driving electric generators.

Gas turbine engines are usually arranged on a base plate surrounded by an enclosure protecting the gas turbine engine and instrumentalities thereof from the environment. A filter arrangement is provided at the inlet of the gas turbine system for filtering air ingested by the compressor of the gas turbine engine. The filtered air is delivered to the inlet of the air compressor through an inlet plenum. Compressed air is then delivered to a combustor, mixed with liquid or gaseous fuel and the mixture is ignited to produce compressed combustion gases which are expanded in one or more turbines to generate power. Part of the power is used to drive the compressor and surplus power is made available on a load coupling for driving a load connected to the gas turbine engine.

FIG. 1 illustrates a gas turbine engine using an air derivative gas turbine and having a current art air inlet plenum arrangement at the cold end of the gas turbine engine.

The gas turbine engine 100 comprises a gas generator 103 in turn comprised of an air compressor 105, a combustor 107 and a high pressure turbine 109. Downstream from the high pressure turbine 109 a power turbine or low pressure turbine 111 is arranged. Exhaust combustion gases are discharged through an exhaust plenum 113 and a stack (not shown). A load coupling 115 extends through the exhaust plenum and drives a load (not shown). At the cold end of the gas turbine engine 100 an air inlet plenum 117 is connected to an annular inlet 121 of the air compressor 105. The air inlet plenum 117 is usually comprised of a box-shaped structure made of steel. The top of the air inlet plenum 117, shown at 117T in FIG. 1 is connected to a clean air delivery duct (not shown), which is in turn connected to a silencer arrangement and a filter system for cleaning the environment air ingested by the air compressor 105. In some known embodiments, the gas generator 103 is supported by the air inlet plenum 117 through a support 123.

In some known embodiments, the air inlet plenum 117 provides for an axial inlet flow, i.e. the interior of the air inlet plenum 117 is shaped so as to generate an axially oriented air flow, which enters the compressor annular inlet 121. The axial flow arrangement is usually provided when air derivative gas turbines are used, which are provided with a compressor nose 105N. The interior of the air inlet plenum 117 is therefore empty in front of the air compressor nose 105N, allowing a free air flow from the air inlet 117T through the compressor inlet 121.

Known air inlet plenum structures are particularly heavy and cumbersome. When the gas generator 103 of the gas turbine engine 100 has to be removed, for example for replacement purposes or maintenance, complex operations must be carried out to dismantle at least partly of the air inlet plenum 117.

There is therefore a need for an improved air inlet plenum structure which at least partly solves or alleviates the drawbacks of the known in air inlet plenum structures.

### SUMMARY OF THE INVENTION

The subject matter disclosed herein particularly refers to an air inlet plenum for a gas turbine system, wherein the air inlet plenum is made mainly of fiber-reinforced plastic composite material. The composite material structure makes the air inlet plenum less expensive and extremely light. Moreover, the air inlet plenum has removable portions, which can easily be detached from a main body of the air inlet plenum, to simplify removal of part of the turbomachines forming the gas turbine engine, for example the gas generator or the air compressor.

While current art air inlet plenums made of stainless steel may have a weight in the range of several tons, e.g. between 4000 and 5000 kg, a corresponding air inlet plenum made of glass fiber-reinforced plastic composite can weigh less than 1000 kg, e.g. between 500 and 700 kg. The removable portions of the air inlet plenum, being made of composite material as well, have a reduced weight which makes removal thereof easy, involving a limited amount of labor, so that maintenance operations requiring removal of turbomachine components are made quicker, safer and less invasive than when current art air inlet plenums are used.

Thus, according to some embodiments, the subject matter disclosed herein relates to an air inlet plenum for a gas turbine engine, comprising: a hollow body having an air inlet aperture and an air outlet aperture arranged and configured for connection to the gas turbine engine; at least one removable portion, which is removable from the hollow body when the air inlet plenum is connected to a gas turbine engine; wherein the air inlet plenum is at least partly made of fiber-reinforced plastic.

Embodiments of the removable portion of the air inlet plenum can have a weight of 40 kg or less and more particularly of 20 kg or less.

According to particularly useful embodiments, the at least one removable portion of the air inlet plenum is a portion of a connection flange, which surrounds an air outlet aperture and which provides a connection between the main body of the air inlet plenum and the inlet of the compressor of the gas turbine engine.

In some embodiments, the connection flange is comprised of two opposite removable portions, so that removal of the compressor and/or other turbomachine components of the gas turbine engine can be performed selectively on either one or the other of two sides of the gas turbine system, depending upon the system layout. In some embodiments the connection flange is formed by two substantially symmetrical parts, each removable from the main body of the air inlet plenum.

The composite material air inlet plenum disclosed herein can be designed for axial air inlet or radial air inlet gas turbine engines. Use of the air inlet plenum disclosed herein in an axial airflow design is particularly useful, since it allows reducing the dimension of the air inlet plenum in the axial direction. As a matter of fact, using a composite material allow the inner surface of the air inlet plenum to be shaped so as to form an air-flow guiding surface, for instance an inner surface which has as smooth curvature from an air inlet aperture towards an air outlet aperture of the hollow body of the air inlet plenum. The guiding curved surface reduces turbulence in the air-flow and makes it possible to design the inner volume of the air inlet plenum substantially smaller than in current-art air inlet plenums, which have a substantially square cross-section and wherein a rather extensive axial direction is required to obtain a sufficiently smooth air-flow at the inlet of the air compressor.

According to a further aspect, the subject matter disclosed herein relates to a gas turbine engine system comprising: a gas turbine engine, and an air inlet plenum; wherein the air inlet plenum has an air outlet aperture arranged and configured for connection to the gas turbine engine and an air inlet aperture; wherein at least one portion of the air inlet plenum is removable when the air inlet plenum is connected to the gas turbine engine; and wherein the air inlet plenum is at least partly made of fiber-reinforced plastic.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the embodiments of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a gas turbine arrangement with an inlet plenum according to the current art;

FIG. 2 illustrates a side and partial sectional view of a gas turbine arrangement according to one exemplary embodiment of the present disclosure;

FIGS. 3 and 4 illustrate axonometric views of an inlet plenum according to an exemplary embodiment;

FIG. 5 illustrates a detail of the connection flange of the inlet plenum;

FIG. 6 illustrates an enlargement of FIG. 5; and

FIGS. 7, 8, 9, and 10 illustrate a sequence for removal of the gas generator.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

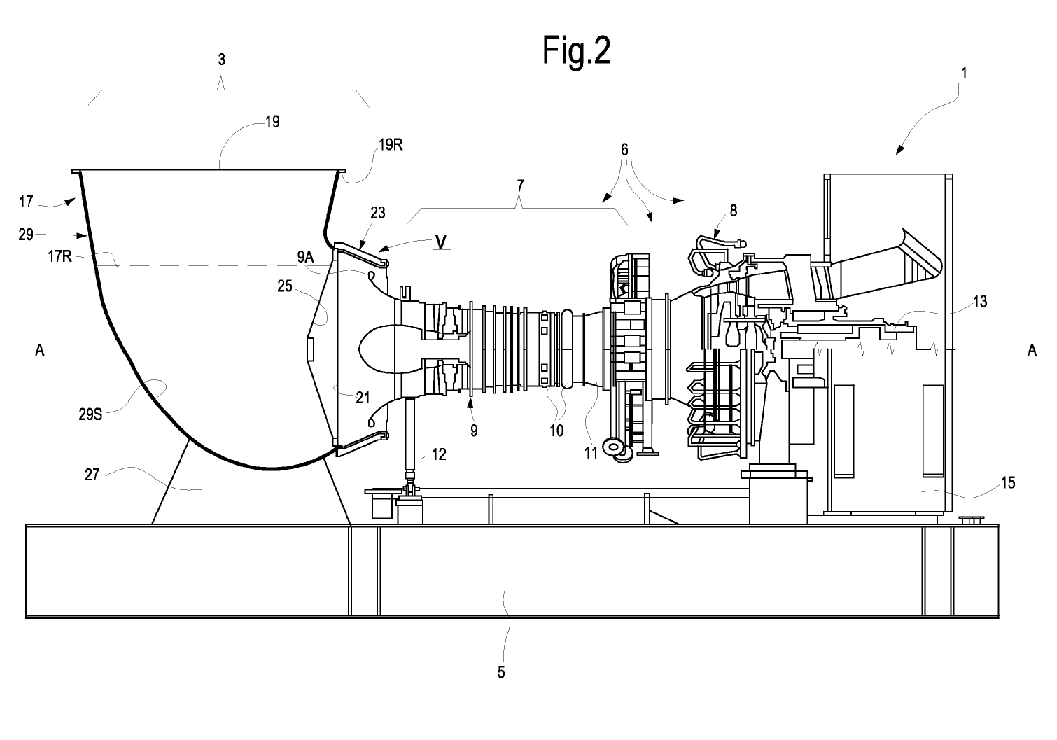

FIG. 2 illustrates a schematic side view of a gas turbine engine system 1 comprised of an air inlet plenum 3. The gas turbine engine system 1 further comprises a base plate 5, whereon the turbomachines are supported. In some embodiments the gas turbine engine system can comprise an aeroderivative gas turbine engine globally labeled 6. The gas turbine engine 6 can be comprised of a gas generator 7 and a power turbine or low pressure turbine 8. The gas generator 7 is in turn comprised of an air compressor 9, a combustor 10 and a high pressure turbine 11.

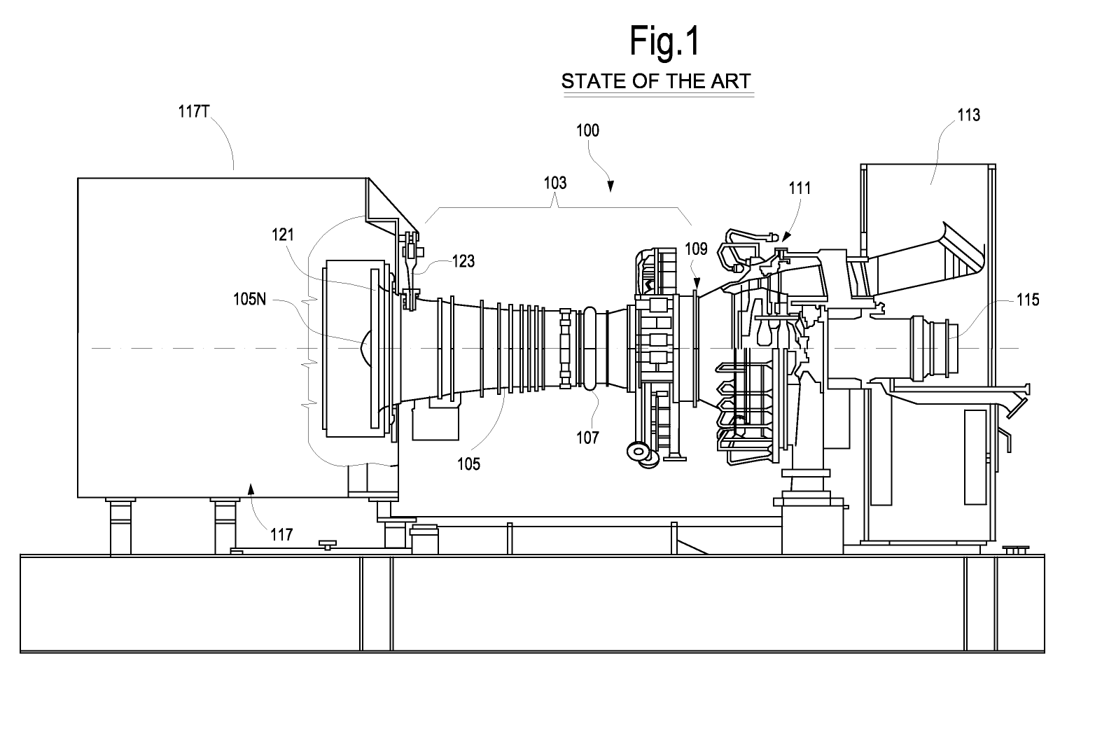

The cold end of the gas turbine engine 6 can be supported by the base plate 5 through supporting struts 12 arranged underneath the inlet side of the air compressor 9, so that the weight of the gas turbine engine is directly supported by the base plate 5 rather than by the air inlet plenum 3 as in some embodiments according to current art (of the FIG. 1).

Air ingested by the air compressor 9 is mixed with fuel in the combustor 10, the air-fuel mixture is ignited and the high-temperature, high-pressure combustion gases thus generated are expanded sequentially in the high pressure turbine 11 and in the low pressure turbine or power turbine 8. Power available on the shaft of the power turbine 8 is used to drive a load (not shown) through a load coupling 13. Exhausted combustion gases are discharged through an exhaust plenum 15.

The gas generator 7 can be, for example, a LM2500, LM2500+, LM2500+G4 gas generators available from General Electric AE, USA. Suitable power turbines 8 can be GE Oil & Gas/Nuovo Pignone PGT25/PGT25+ Gas Turbines. Further Suitable power turbines can be DR-61 and VECTRA® 40G power turbines available from Dresser Rand, USA.

According to some embodiments, the air compressor 9 is comprised of an annular inlet 9A which is fluidly connected to the air inlet plenum 3.

The air inlet plenum 3 can be comprised of a hollow body 17 having an air inlet aperture 19. The air inlet aperture 19 can be connected to a clean-air delivery duct (not shown) in turn connected to a silencer arrangement and a filter system, through which the air is delivered before being ingested by the air compressor 9.

According to some embodiments, the top portion of the hollow body 17, where the air inlet aperture 19 is located, has a square or rectangular shape. The air inlet aperture 19 can be surrounded by a rim 19R.

The hollow body 17 of the air inlet plenum 3 is further comprised of an air outlet aperture 21 and a connection flange 23 surrounding the air outlet aperture 21 and establishing a connection between the hollow body 17 of the air inlet plenum 3 and the annular inlet 9A of the air compressor 9. In some embodiments the air outlet aperture 21 of the hollow body 17 is circular in shape. The connection flange 23 can be substantially frustum-conical.

Upstream from the air outlet aperture 21 a filter or mesh 25, for example conical in shape, can be arranged, for preventing extraneous matter from entering the air compressor 9.

In some embodiments, the air inlet plenum 3 is supported by supporting legs 27 on the base plate 5 of the gas turbine engine system 1. In other embodiments, the air inlet plenum 3 can be mounted on a separate baseplate directly on foundations whereon the baseplate 5 is placed.

In some embodiments, the hollow body 17 comprises a side wall 29 opposite the air outlet aperture 21, which extends from the rim 19R downwards to the bottom of the hollow body 17, forming a curved surface 29S extending down to the air outlet aperture 21. The surface 29S of the side wall 29 forms an air guiding surface, which generates a smooth airflow in an axial direction entering the inlet of the air compressor 9 in an axial direction. The hollow body 17 of the air inlet plenum 3 can be entirely empty between the wall 29 and the opposing air outlet aperture 21.

According to some embodiments, the wall 29 can be provided with a port 31 which is closed by a removable closure 33, for maintenance purposes or inspection.

According to embodiments, the connection flange 23 is comprised of a plurality of separable portions. In some exemplary embodiments the connection flange 23 is formed by two flange portions 23L and 23R. The two portions 23L, 23R of the connection flange 23 both develop around approximately 180° and are therefore substantially symmetrical with respect to a vertical plane containing the axis A-A of the gas turbine engine 6.

At least one, and in another embodiment both flange portions 23L, 23R can be removable from the hollow body 17 of the air inlet plenum 3.

In some embodiments, each flange portion 23L, 23R is provided with two end ribs 35, which abut one against the other when the connection flange 23 is mounted on the hollow body 17 of the air inlet plenum 3. The ribs can extend radially from the flange portions and are adjacent the vertical plane which separates the two flange portions 23L, 23R.

Through holes 35H can be provided in both end ribs 35 of the two flange portion 23L, 23R. Connection bolts can be inserted through the through holes 35H to connect the two flange portions 23L, 23R to one another in the assembled condition.

Each flange portion 23L, 23R can further be provided with a semi-annular rim 37 for connection to a ring 39 constrained to the hollow body 17 and surrounding the air outlet aperture 21 thereof. In some embodiments connection bolts 40 are used to connect the two semi-annular rims 37 to the rig 39.

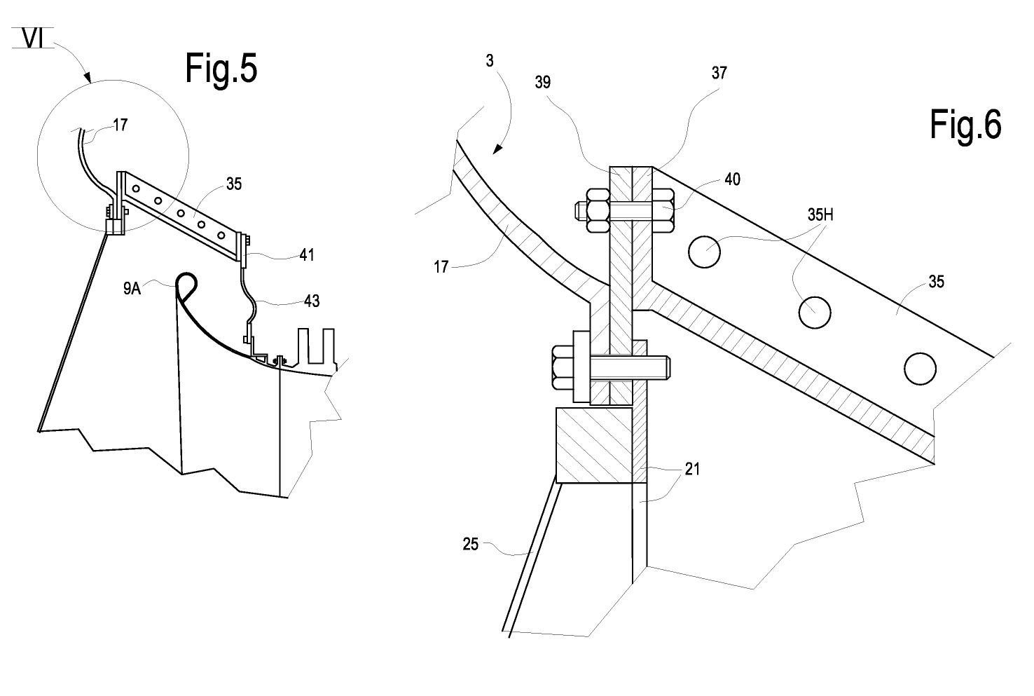

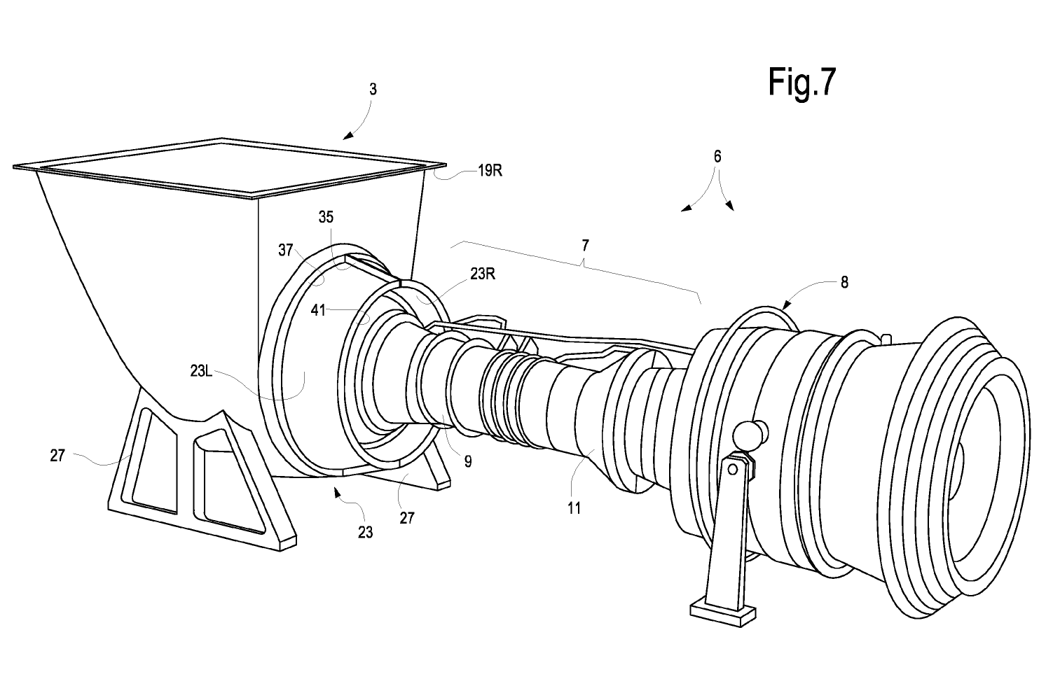

Both flange portions 23R, 23L can further be provided with respective semi-annular rims 41 arranged at the ends of the flange portions opposite the respective semi-annular rims 37. A sealing diaphragm 43 can be connected on the one side to the semi-annular rims 41 of the two flange portions 23L and 23R and on the other side to the annular inlet 9A of the air compressor 9, as best shown in FIG. 5. The sealing diaphragm 43 can be made of a flexible or resilient material, such as rubber or the like.

The above described structure of the air inlet plenum 3 simplifies the operations needed when parts of the gas turbine engine 6 will be removed, e. g. when the gas generator 7 is required to be removed from the power turbine 8, for maintenance or replacement purposes, for instance.

According to some embodiments of the gas turbine engine, in order to remove the gas generator 7 from the power turbine 8, the gas generator 7 will be displaced axially to be distanced from the power turbine 8. Afterwards, the gas generator 7 can be removed with a transverse motion, i.e. moving it transversely to the axis A-A of the gas turbine engine 6.

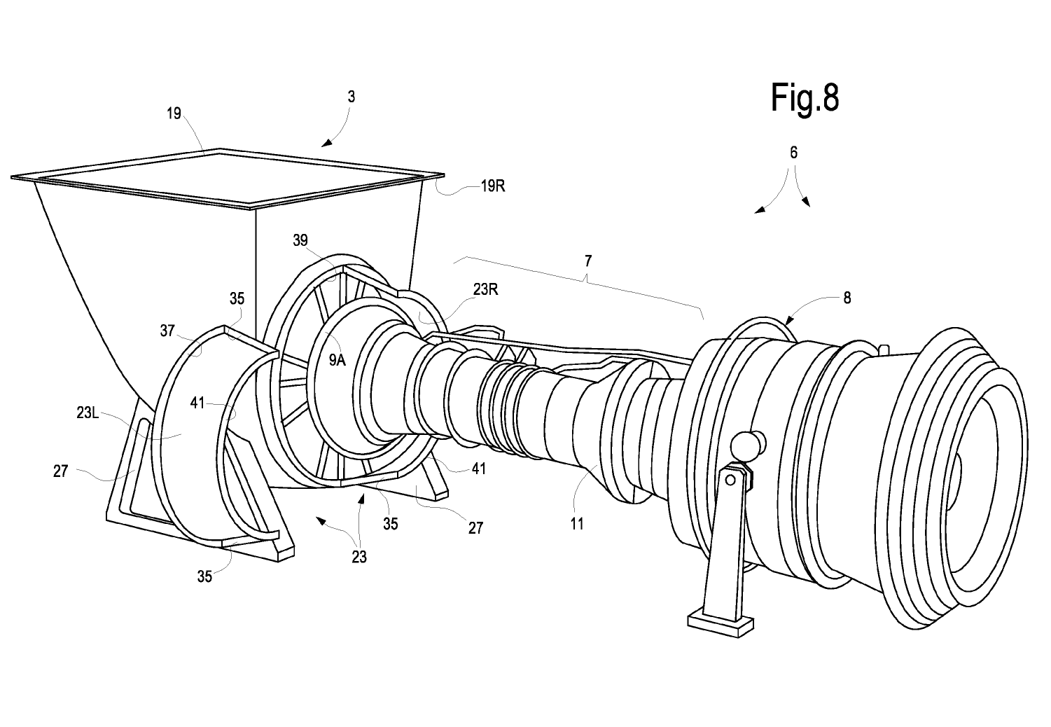

Using an air inlet plenum 3 as described above, the gas generator 7 can easily be removed from the turbine engine system 1 as follows. FIGS. 7-10 illustrate a gas generator removal sequence. Starting from the assembled condition, firstly the sealing ring 43 is detached from the rims 41 of the two flange portions 23L and 23R (FIG. 7).

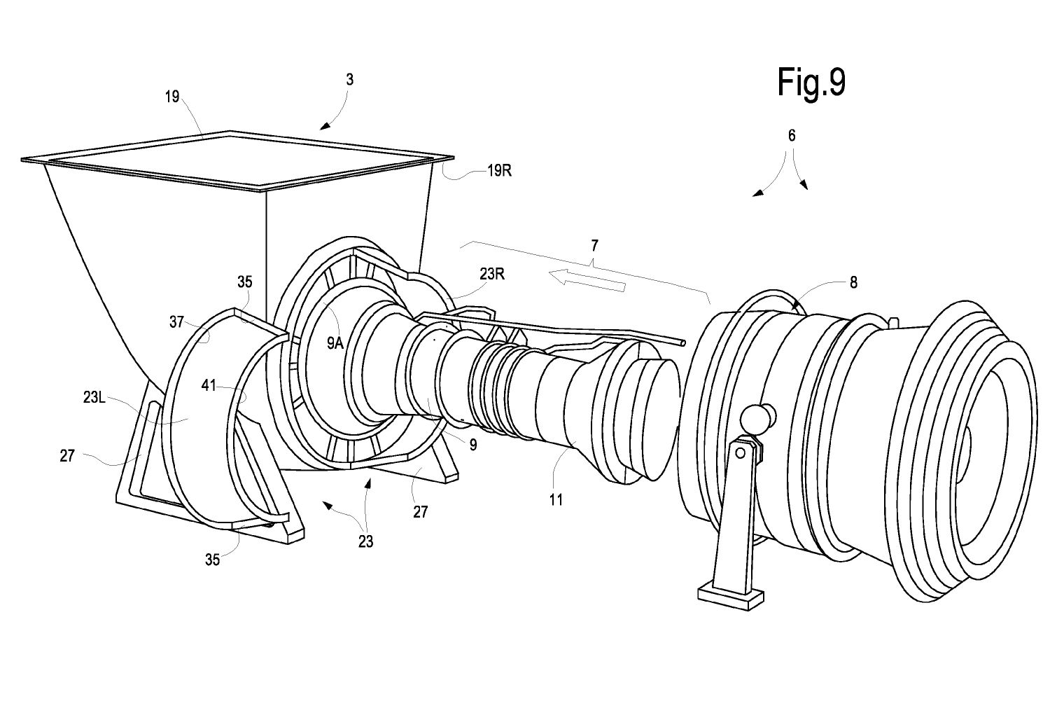

Afterwards, at least one of the two flange portions 23L and 23R can be removed from the main hollow body 17 of the air inlet plenum 3 (FIG. 8). The flange portion which is removed is selected based on the layout of the gas turbine engine system 1 and more specifically depending upon on which side of the base plate 5 shall the gas generator 7 be removed from the system. In the exemplary embodiment illustrated in the drawings the flange portion 23L is removed.

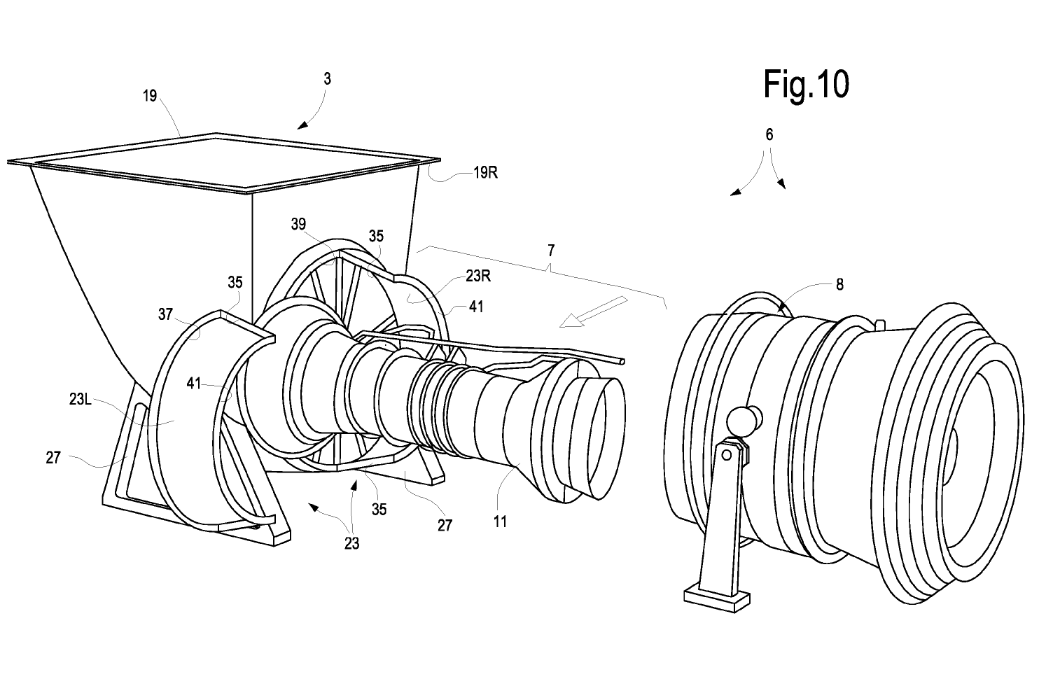

The gas generator 7 can thus be displaced axially, i.e. parallel to the axis A-A towards the interior of the air inlet plenum 3, to an extent sufficient for the gas generator 7 to be detached from the power turbine 8 (FIG. 9). Displacement can be performed by means of a crane arranged in the turbine enclosure, not shown.

Once the gas generator 7 has been sufficiently distanced from the power turbine 8, it will be moved sideways orthogonal to the axis A-A (FIG. 10). The sideways movement is allowed by the clearance obtained by removing the flange portion 23L. The remaining parts of the air inlet plenum 3 can remain in place.

If the gas generator 7 is to be moved away in the opposite direction transverse to the axis A-A, the flange portion 23R will be removed instead of the flange portion 23L. The remaining steps of the removal procedure described above remain the same.

In some embodiments, the air inlet plenum 3 is made of reinforced composite material. More specifically, according to some embodiments the air inlet plenum 3 is made of fiber-reinforced plastic composite material. Since the dynamic and static loads on the air inlet plenum 3 are relatively small, glass fiber-reinforced plastic composite material offer sufficient mechanical strength. Composite material using carbon fibers as reinforcing elements is not ruled out. However, it has been noticed that less expensive glass fiber-reinforced plastic (GFRP) provide sufficient mechanical strength at moderate costs.

More specifically, the hollow body 29 can be formed substantially entirely of fiber-reinforced plastic composite material. Only minor components, parts or inserts made of a different material, e.g. metal, can be provided. For example metal inserts can be embedded in the fiber-reinforced plastic material around the air inlet aperture 29 and the air outlet aperture 21. Metallic inserts can be provided, for example, in those locations where threaded holes or smooth through holes are required for connection purposes. Along the rim 19R metallic inserts can be embedded in a GFRP composite material forming the main body of the air inlet plenum. The metallic inserts can be provided with threaded or smooth blind or through holes for connection of the air inlet plenum to surrounding structures, e.g. the enclosure of the gas turbine system and/or the clean air delivery duct.

According to some embodiments, also the flange portions 23L and 23R are formed basically of fiber-reinforced plastic composite material, more particularly glass fiber-reinforced plastic composite material.

The flange portions 23L and 23R can be comprised of metallic inserts embedded in a fiber-reinforced plastic matrix for example along the semi-annular rims 37 and 41 as well as along the ribs 35, the metallic inserts forming for instance through holes provided for the connection bolts, which connect the two flange portions 23R, 23L to the ring 39 and the opposite facing rims 35 to one another.

Using fiber-reinforced plastic composite material has several advantages over steel construction as used in the current art air inlet plenums. On the one hand, the fiber-reinforced plastic composite material can be shaped according to any complex shape as required, for example for aerodynamic purposes. The curved shape of the wall 29 of the hollow body 17, for example, can be formed easily if a fiber-reinforced plastic is used, while it would be much more complex to manufacture in steel.

The hollow body 17 of the air inlet plenum 3 can be formed for example using a mold on which the various parts of the hollow body 17 are formed by a layer-by-layer deposition technique.

According to some embodiments, an open molding manufacturing process can be used, such as Hand Lay Up processes which provide for layering reinforcing fibers in form of textures or chopped mat, and resin. According to further exemplary embodiments, open molding manufacturing processes such as Spray Up processes can be used, involving the deposition of plastic and fibers layers directly on the mold. Vacuum infusion can be applied if needed. Open molding manufacturing processes are particularly suitable as they offer a good compromise between quality of the final article of manufacture and manufacturing costs.

In further exemplary embodiments, Resin Transfer Molding (RTM), or Compression Molding processes can be used depending on economic aspects related to production volume rate.

Supports 27 can be manufactured separately and attached subsequently to the hollow body 17. In other embodiments, the supports 27 can be formed along with the hollow body 17 in the same mold.

In an embodiment, the flange portions 23L, 23R and the closure 33, if provided, are formed separately. The closure 33 can be provided with metallic inserts around the perimeter thereof, for connection to the hollow body 17 of the air inlet plenum 3, wherein the latter can be provided with a peripheral connection flange or rim surrounding the aperture closed by closure 33.

According to some embodiments, the actual structure of the air inlet plenum 3 can be different in the various parts thereof, for example a variable amount of fibers or a selective orientation thereof can be provided along different portions of the air inlet plenum 3 depending upon the mechanical properties which the air inlet plenum 3 has to satisfy. Improved resistance can be achieved for instance around the air inlet aperture 19 and the air outlet aperture 21 as well as along the corners or edges of the hollow body 17, e.g. providing a higher amount of fibers in those positions and/or an orientation of those fibers along the line of force corresponding to the mechanical stresses generated during use.

Some particularly stressed parts or areas of the air inlet plenum 3 can be provided with a sandwich structure, i.e. a structure comprised of two outer skins made of fiber-reinforced plastic composite material, and an intermediate core arranged between the outer skins This sandwich structure, known per se, increases the flexural strength of the structure. For example, the closure 33 can be provided with a sandwich structure as disclosed, to better resist flexural stresses due to the pressure difference between the interior and the exterior of the air inlet plenum 3, caused by the strong section operated by the air compressor 9.

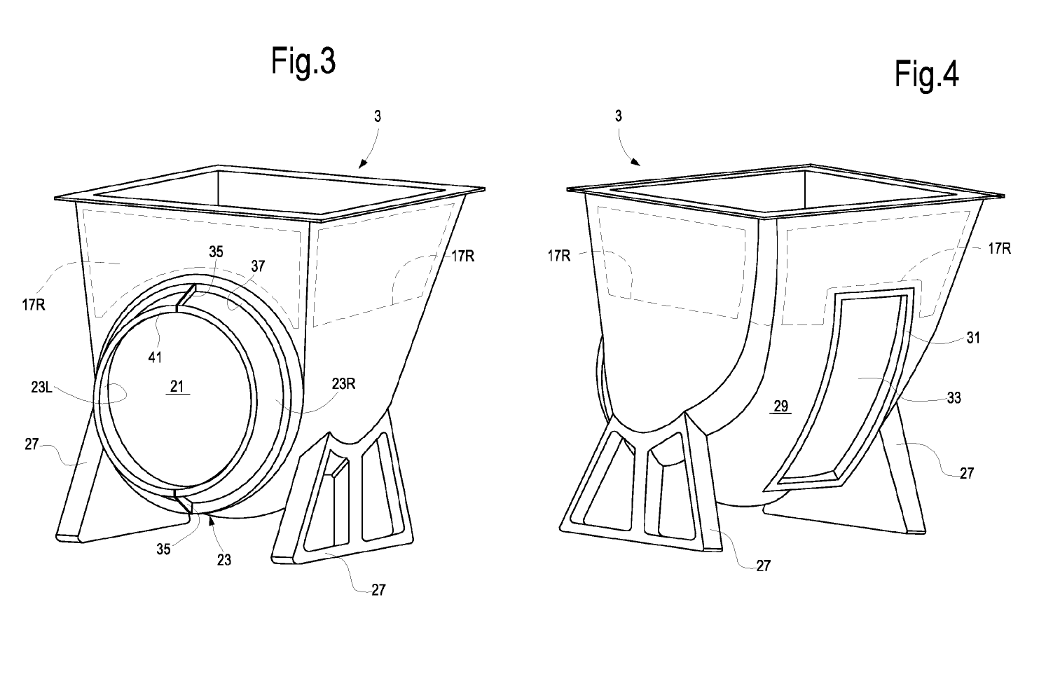

Also the upper area of the side walls of the hollow body 17, as shown schematically in dashed lines at 17R (see FIGS. 3 and 4) can be partly or entirely made of a sandwich structure with an inner core improving the flexural resistance of those parts of the inlet plenum 3.

Reinforced parts of the inlet plenum, for example along the edges of the supports 27, can be obtained also by increasing the thickness of the fiber-reinforced plastic composite material.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. An air inlet plenum for a gas turbine engine, comprising: a hollow body having an air inlet aperture and an air outlet aperture arranged and configured for connection to the gas turbine engine; at least one removable portion, which is removable from the hollow body when the air inlet plenum is connected to a gas turbine engine; wherein the air inlet plenum is at least partly made of fiber-reinforced plastic.

2. The air inlet plenum of claim 1, having a weight of less than 1000 kg.

3. The air inlet plenum of claim 1, wherein said at least one removable portion has a weight of 40 kg or less, and preferably of 20 kg or less.

4. The air inlet plenum of claim 1, wherein said air outlet is provided with a connection flange formed by at least two flange portions, and wherein at least one of said flange portions is removable from the hollow body and forms said at least one removable portion of the air inlet plenum.

5. The air inlet plenum of claim 4, wherein both said at least two flange portions are removable from the hollow body.

6. The air inlet plenum of claim 4, wherein said connection flange is formed by two substantially symmetrical flange portions, and wherein at least one of said two flange portions is removable from the hollow body.

7. The air inlet plenum of claim 4, wherein both said two flange portions are removable from the hollow body.

8. The air inlet plenum of claim 4, wherein said connection flange is provided with a sealing ring.

9. The air inlet plenum of claim 1, wherein said fiber-reinforced plastic is a glass fiber-reinforced plastic.

10. The air inlet plenum of claim 1, wherein a portion of the hollow body has a reinforced sandwich structure, comprised of an outer skin and an inner skin made of reinforced fiber-reinforced plastic, and an inner core there between.

11. (canceled)

12. The air inlet plenum of claim 1, wherein the hollow body has a curved side and bottom wall forming an air guiding surface extending from the air inlet aperture towards the air outlet aperture.

13. The air inlet plenum of claim 1, comprising an openable access port.

14. (canceled)

15. (canceled)

16. A gas turbine engine system comprising: a gas turbine engine, and an air inlet plenum; wherein the air inlet plenum has an air outlet aperture arranged and configured for connection to the gas turbine engine and an air inlet aperture; wherein at least one portion of the air inlet plenum is removable when the air inlet plenum is connected to the gas turbine engine; and wherein the air inlet plenum is at least partly made of fiber-reinforced plastic.

17. The gas turbine engine system of claim 16, wherein the air inlet plenum is designed and configured to generate an axial air inlet flow entering the gas turbine engine.

18. The gas turbine engine system of claim 16, wherein the gas turbine engine comprises an air compressor provided with an annular inlet for receiving air from the air inlet plenum, and wherein the annular inlet projects in the air inlet plenum.

19. The gas turbine engine system of claim 16, wherein the air inlet plenum is provided with a connection flange.

20. The gas turbine engine system of claim 18, wherein the air inlet plenum is provided with a connection flange which surrounds the annular inlet of the air compressor.

21. (canceled)

22. (canceled)

23. (canceled)

24. (canceled)

25. The gas turbine engine system of claim 19, wherein a sealing ring is arranged between the connection flange and the gas turbine engine.

26. The gas turbine engine system claim 16, wherein said gas turbine engine comprises a gas generator and a power turbine, and wherein the gas generator is detachable from the power turbine by displacing the gas generator axially away from the power turbine.

27. A gas turbine engine system comprising a gas turbine engine and an air inlet plenum according to claim 1.
